(19) United States
(12) Patent Application Publication
(10) Pub. No.: US 2010/0092229 A1
(43) Pub. Date: Apr. 15, 2010

(54) Product

(75) Inventor: Sara Quaggia, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/447,287

(22) PCT Filed: Oct. 22, 2007
(86) PCT No.: PCT/GB2007/004001

§ 371 Date: Aug. 5, 2009

(30) Foreign Application Priority Data
Oct. 28, 2006 (GB) 0621498.5

(51) Int. Cl. B05C 17/02

(52) U.S. Cl. 401/208

(57) ABSTRACT

An applicator for a detergent composition comprises a container. The container has at one end a housing with an opening therein. An applicator cylinder is located within and extends outwardly from the opening.

This invention relates to an applicator and particularly to an applicator for applying a detergent product to a textile or similar absorbent surface.

It can be advantageous to pre-treat particular soiled or stained areas of textile materials with a liquid detergent product prior to washing the textiles in the conventional manner either by hand or in a washing machine. An object of the present invention is to provide a device in the form of an applicator which can be used to apply such a pre-treatment to selected areas accurately and without wastage of the product through either the use of an excess amount of product or its application over an area greater than the stained or soiled areas. The device should also be sealed against leakage when not in use.

According to a first aspect of the invention there is provided an applicator for a detergent composition comprising a container having at one end a housing with an opening therein, an applicator cylinder located within and extending outwardly from the opening.

We have found that when an applicator in accordance with the first aspect of the invention is used to dispense a detergent composition (e.g. to a textile material such as an item of clothing or a carpet) the applicator is particularly beneficial. It is suggested that one reason for this impressive performance is the relatively high surface area of the dispensing cylinder. This means that dosing of the detergent composition from the applicator onto the surface being cleaned and movement of the detergent composition on the surface being cleaned is enhanced.

Generally the cylinder mounted within the opening such that it can roll. Preferably during use the applicator will be moved in a “forwards-backwards” motion such that the cylinder is rolled about its axis.

Preferably the cylinder is mounted in the opening at an axial portion at each end of the cylinder.

To improve rubbing of the detergent composition on to the surface being cleaned and to improve the friction grip between the cylinder and the surface being cleaned preferably the cylinder is grooved. It has also been found that by application of grooves to the cylinder dirt removal from the surface being cleaned is greatly enhanced.

Generally the cylinder has a plurality of grooves on its surface. Usually the groves are arranged such that the entire surface of the cylinder is grooved. Namely it is preferred that the groves are arranged adjacent to one another and run around the entire circumference of the cylinder.

Preferably the grooves are arranged such that they are substantially parallel to the axis of the cylinder. However, in a preferred embodiment the grooves are arranged such that they are angled slightly to the axis of the cylinder. In this way the grooves form a mild helix around the axis of the cylinder.

The cylinder preferably has a length of around 5 cm (see below for description of the size of the applicator). The radius of the cylinder is preferably around 1 cm. The grooves on the cylinder have a width of 0.5-5 mm, preferably 1-3 mm, most preferably about 2 mm.

The applicator is preferably sized such that it can be accommodated by a hand of a user. Usually the housing is dimensioned such that its width is around 5 cm. Generally the housing is sculpted to form a grip so that it can be held effectively in a hand of a user.

The applicator generally includes a cap to cover the cylinder when not in use.

Usually the applicator includes a valve to control the flow of the treatment composition. For example the valve may restrict the flow of the composition such that a user has to apply a slight pressure to the housing to cause the treatment composition to pass by/through the valve. In this way accidental discharge such as when the housing is transported/stored (particularly when in an incorrect orientation, e.g. such as being upside down) is minimised.

Preferably the applicator comprises a plastics material.

The fabric treatment composition is preferably formulated such that it is easily dispensed. Preferably the fabric treatment composition is a liquid/gel.

Preferably the fabric treatment composition comprises a bleach. Where present the composition comprises from 0.001% to 99.99%, preferably 0.001% to 7%, preferably 2% to 6%, most preferably about 7%, by weight, of bleach. The bleach is preferably peroxide bleach, most preferably hydrogen peroxide. Peroxide sources other than H₂O₂ can be used.

Preferably the fabric treatment composition comprises a surfactant. Where present the composition comprises from 0.001% to 99.99%, preferably 0.05% to 5%, by weight of surfactants.

The surfactant is, for example, an anionic or nonionic surfactant or mixture thereof. The nonionic surfactant is preferably a surfactant having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C12-15 alkanol condensed with 7 or 3 moles ethylene oxide (Neodol 25-7 or Neodol 25-3), C₁₄₋₁₅ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and oleoyl sarcosinates and mixtures thereof.

Preferably the fabric treatment composition comprises a solvent. Where present the composition comprises from 0% to 99.99% preferably from 0% to 10% by weight, of solvent.

The solvent constituent may comprise one or more alcohol, glycol, acetate, ether acetate or glycol ether. Exemplary alcohols useful in the compositions of the invention include C₂-C₈ primary and secondary alcohols which may be straight chained or branched, preferably pentanol and hexanol. More preferably the solvent is a glycol ether. Preferred examples of glycol ethers include glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

Specific and preferred solvents are selected from propylene glycol methyl ether, dipropylene glycol methyl ether, dipropylene glycol propyl ether, dipropylene glycol butyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

Most preferably the solvent or mixture of solvent is from the propanol series (Dowanol P-series) and among these Dipropylene Glycol n-Propyl Ether, Dipropylene Glycol n-Butyl Ether and Propylene Glycol Phenyl Ether. These are commercially available from Dow Chemicals as Dowanol DPnP, Dowanol DPnB and Dowanol PPH respectively.

Other useful solvents are hydrotropes such as sodium toluene sulfonate and sodium cumene sulfonate, short-chain alcohols such as ethanol and isopropanol, and the like. They can be present in the compositions as only solvents or in combination with other solvents.

Preferably the fabric treatment composition comprises a builder. Where present the composition comprises from 0% to 99.99% preferably from 0% to 10% by weight, of builder.

The fabric treatment composition may comprise minor amounts of various optional ingredients, including enzymes, dye transfer inhibition agents, dye catchers, preservatives, anti-static agents, fragrances, odour absorbing components

The pH range of the fabric treatment composition is typically in the from about 3 to about 8, preferably about 6.

According to a second aspect of the invention there is provided the use of an applicator to apply a detergent composition to a textile, wherein the applicator comprises a container (containing a detergent composition), the container having at one end a housing with an opening therein, an applicator cylinder located within and extending outwardly from the opening.

Preferably the use of the applicator is as a pre-spotter/pre-treater for treatment of stains on clothing/carpets before washing. Alternatively the applicator may be used to treat a stain on clothing in an “out-of home” environment.

The invention is now described with reference to the following non-limiting Example.

### Example of a Fabric Treatment Composition

Preferred examples of a fabric treatment composition are below.

| | Raw | End |
|---|---|---|
| Component | Material % | Composition % |
| Deionized Water (<2 μS/cm) | 81.900 | 85.786 |
| Sodium Hydroxide 50% | 0.80 | |
| Alkylbenzene Sulphonic Acid | 3.00 | 3.20 |
| Oxo Alcohol C₁₂-C₁₆ + 7EO | 5.00 | 5.00 |
| Oxo Alcohol C₁₂-C₁₆ + 3EO | 2.00 | 2.00 |
| Sodium Citrate | 0.50 | 0.50 |
| HEDP L | 0.20 | 0.12 |
| Fragrance | 0.20 | 0.20 |
| Hydrogen Peroxide (50%) | 6.00 | 3.00 |
| PVNO | 0.30 | 0.09 |
| Optical Brightener | 0.10 | 0.10 |
| | 100.000 | 100.000 |

1. A detergent composition applicator comprising a container having at one end a housing with an opening therein, an applicator cylinder located within the housing and extending outwardly from the opening.

2. An applicator according to claim 1, wherein the cylinder mounted within the opening can roll.

3. An applicator according to claim 2, wherein the cylinder is mounted at an axial portion at each end of the cylinder.

4. An applicator according to claim 1 wherein the cylinder is grooved

5. An applicator according to claim 4, wherein the grooves are arranged such that they are adjacent one another and run around the entire circumference of the cylinder.

6. An applicator according to claim 4, wherein the grooves run along the axis of the cylinder.

7. An applicator according to claim 4, wherein the groves are slightly angled with respect to the axis of the cylinder.

8. An applicator according to claim 4 wherein the grooves have a width of 0.5-5 mm.

9. An applicator according to claim 1, wherein the housing is sculpted to form a grip.

10. An applicator according to claim 1, wherein the applicator includes a cap to cover the cylinder when not in use.

11. (canceled)

12. A method of applying a quantity of a pre-spotter or pre-treater for treatment of stains on clothing before washing, comprising the steps of:
providing an applicator according to claim 1; and,
delivering a quantity of a pre-spotter or pre-treater composition to a satin on clothing prior to washing the clothing.

13. An applicator according to claim 8, wherein the grooves have a width of 1-3 mm.

14. An applicator according to claim 13, wherein the grooves have a width of about 2 mm.
